(19) United States
(12) Patent Application Publication
(10) Pub. No.: US 2016/0321690 A1
(43) Pub. Date: Nov. 3, 2016

(54) MOBILE DEVICE USER INTERFACE WITH DYNAMIC ADVERTISING CONTROL INTERFACE AREA FOR INCENTIVIZING USER VIEWING OF ADVERTISEMENTS

(71) Applicant: Paschar LLC, San Francisco, CA (US)

(72) Inventor: Peter Ma, San Francisco, CA (US)

(21) Appl. No.: 14/700,238

(22) Filed: Apr. 30, 2015

(51) Int. Cl. G06Q 30/02; H04M 1/725

(52) U.S. Cl. CPC G06Q 30/0255; H04M 1/72577; G06Q 30/0267

(57) ABSTRACT

A method of providing advertising on a mobile device is provided. The method provides an advertising control interface area as a top layer on an application interface layer of an application executing on the mobile device. The user launches full advertisements which generally consume more display space than the advertising control interface area by performing an advertising control interface area selection gesture. A user advertisement queue is dynamically updated as the user views full advertisements. Once the user views all of the advertisements in the queue, the advertisement control interface area is removed from the display for a selected period of time, providing full access to the entirety of the application interface area, which incentivizes mobile device users to view the full advertisements in their queue.

### FIELD

The present disclosure relates to techniques for providing advertising with mobile device applications, and more specifically, to techniques that incentivize users to view advertisements.

### BACKGROUND

With the advent of mobile devices such as iPhones, iPads, Android Tablets, hybrid tablets, and the iPod Touch, application developers have provided large numbers of applications or “apps” that allow users to perform a wide variety of different tasks. Applications allow users to process, receive and transmit an endless array of information in the form of text, images, sounds, animations, and video. While some application developers choose to charge subscription fees for access to their applications, others choose to make the applications free to users and to generate revenue from advertisements presented to users in connection with the applications. However, known advertising techniques suffer from several drawbacks.

One common type of advertisement is the “banner” advertisement often shown at the bottom of a mobile device display as an overlay on an application interface area of an executing application. In certain known techniques, the banner advertisement is linked to a full advertisement that a user can access by performing a selection gesture on the banner. However, in many cases, the user has little or no incentive to click on the banner to obtain the additional information about the advertised goods or services which is provided in the full advertisement. Thus, advertisers are deprived of the full value of their advertisements.

In one known technique, an application is initially provided with advertising but is configured so that after a user views all of the advertisements in an advertisement inventory, the application is deemed “free” and provided without advertising thereafter. Thus, while the user is incentivized to view a particular set of advertisements, no means is provided for incentivizing the user to view advertisements on an on-going basis so that advertising can be provided after the initially advertisement inventory has been exhausted. As a result, the advertising revenue available to the application provider is limited to that which can be generated by an initial set of advertisements.

Thus, a need has arisen for a mobile device advertising solution that addresses the foregoing issues.

### BRIEF DESCRIPTION OF THE DRAWINGS

The disclosure will now be described, by way of example, with reference to the accompanying drawings, in which:

FIG. 1 is front elevational view of a mobile device in a first (portrait) rotational orientation in a plane perpendicular to the Earth's surface with the mobile device in a first operative state displaying a first user interface comprising an advertising control interface area and an application interface area in which an advertising gauge provides an indication of a first number of advertisements in a first advertisement queue;

FIG. 2 is a front elevational view of the mobile device of FIG. 1 in the first (portrait) rotational orientation and in a second operative state displaying a second user interface comprising an advertising control interface area, an application user interface area, and a pop-up menu overlaid on the application user interface area;

FIG. 3 is a front elevational view of the mobile device of FIG. 1 in the first (portrait) rotational orientation and a third operative state displaying a third user interface comprising an application interface area without an advertising control interface area;

FIG. 4 is a front elevational view of the mobile device of FIG. 1 in the first (portrait) rotational orientation and in a fourth operative state displaying a fourth user interface comprising a first advertising interface area;

FIG. 5 is a front elevational view of the mobile device of FIG. 1 in the first (portrait) rotational orientation and in a fifth operative state displaying a second advertising interface area accessed by a selection gesture performed on the first advertising interface area of FIG. 4;

FIG. 6 is a front elevational view of the mobile device of FIG. 1 in the first (portrait) rotational orientation and in a sixth operative state displaying a third advertising interface area accessed by a selection gesture performed on the second advertising interface area of FIG. 5;

FIG. 7 is a front elevational view of the mobile device of FIG. 1 in the first (portrait) rotational orientation and in the first operative state displaying the first user interface comprising an advertising control interface area and an application interface area in which an advertising gauge provides an indication of a second number of advertisements in a first advertisement queue following the launching of advertisements in FIGS. 4-6;

FIGS. 8A and 8B are a flow chart depicting a method of providing advertising on a mobile device which incentivizes users to view full advertisements;

FIG. 9 is a front elevational view of the mobile device of FIG. 1 in a second (landscape) rotational orientation and in a seventh operative state displaying a user interface comprising an advertising control interface area with a graphic having content related to a full advertisement that is accessible by performing a selection gesture on the advertising control interface area; and

FIG. 10 is a front elevational view of the mobile device of FIG. 1 in the first (portrait) rotational orientation and in an eighth operative state displaying a first user interface comprising an advertising banner control interface area and an application interface area in which an advertising gauge provides an indication of a number of advertisements in an advertisement queue.

### DETAILED DESCRIPTION

The present disclosure relates to user interfaces for mobile devices, including mobile smart devices and mobile smart phones, and more particularly, to techniques for providing advertising on graphical user interfaces (GUIs) for such mobile devices. Examples of such mobile devices include the iPhone, Samsung Galaxy, iPad, Android Tablets, hybrid tablets, and the iPod Touch. In general, such mobile devices are portable, handheld devices that communicate wirelessly with other mobile devices and networks and which include the capability of transmitting, receiving, processing, and displaying digital data.

In certain examples, computer executable instructions are stored on a mobile device for generating an advertising control interface area on the mobile device display. The advertising control interface area is provided in a top interface layer that overlays an application interface area corresponding to an executing application on the mobile device. A user can select the advertising control interface area to cause an advertising interface area to be visible on the display. In certain of the methods described herein, a user is incentivized to perform a selection gesture on the advertising control interface area in order to remove the advertising control interface area from the display for a selected period of time.

In the same or other methods, the mobile device is provided with an advertisement queue that contains a plurality of advertisement identifiers, each of which correspond to an advertisement and an advertising interface area that is displayed in response to performing a selection gesture on an advertising control interface area. As the user launches advertisements by selecting the advertising control interface area, the number of advertisement identifiers in the advertisement queue is reduced. If the user selects to remove (or “dismiss”) the advertising control interface area from the mobile device display, the advertising control interface area is removed for a period of time that is determined by the number of advertisement identifiers that are then in the user's queue. As fewer advertisements remain in the queue, the removal or dismissal time increases.

In accordance with a first aspect of the present disclosure, a method of providing advertising on a mobile device display comprises first displaying an advertising control interface area on an application interface area on the display and removing the advertising control interface area from the application interface area for a selected period of time when a number of advertisement identifiers in an advertisement queue reaches a selected number. In accordance with certain examples, the mobile device includes a processor and a non-transitory computer readable storage medium having computer executable instructions stored thereon, and when executed by the at least one processor, the computer executable instructions perform the steps of the first aspect.

In accordance with a second aspect of the present disclosure, a method of providing advertising on a mobile device comprises receiving a first advertisement queue, first displaying an advertising control interface area on an application interface area on the mobile device display, displaying a first advertisement corresponding to a first advertisement identifier from the first advertising queue in response to a first user gesture, displaying a last advertisement corresponding to a last advertisement identifier from the first advertisement queue in response to a second user gesture, and removing the advertising control interface area from the application interface area for a first selected period of time. In certain examples, a mobile device is provided which comprises a processor, and a non-transitory computer readable medium having computer executable instructions stored thereon, wherein when executed by the processor, the computer executable instructions perform the steps of the second aspect.

In accordance with a third aspect of the present disclosure, a method of providing advertising on a mobile device comprises first displaying an advertising control interface area on an application interface area on the mobile device display in accordance with a first advertising control interface area display schedule, adjusting a value of a first total number of advertisements to be displayed to yield a second number of advertisements to be displayed, wherein each advertisement in the first total number of advertisements to be displayed corresponds to an advertisement identifier in a first advertisement queue, and the first total number of advertisements to be displayed corresponds to a first total number of advertisement identifiers in the first advertising queue, modifying the first advertising control interface area display schedule to yield a second advertising control interface area display schedule based on the second total number of advertisements to be displayed, and second displaying an advertising control interface area on the application interface area in accordance with the second advertising control interface area display schedule. In certain examples, a mobile device is provided which comprises a processor and a non-transitory computer readable storage medium having computer executable instructions stored thereon, wherein when executed by the processor, the computer executable instructions perform the steps of the third aspect.

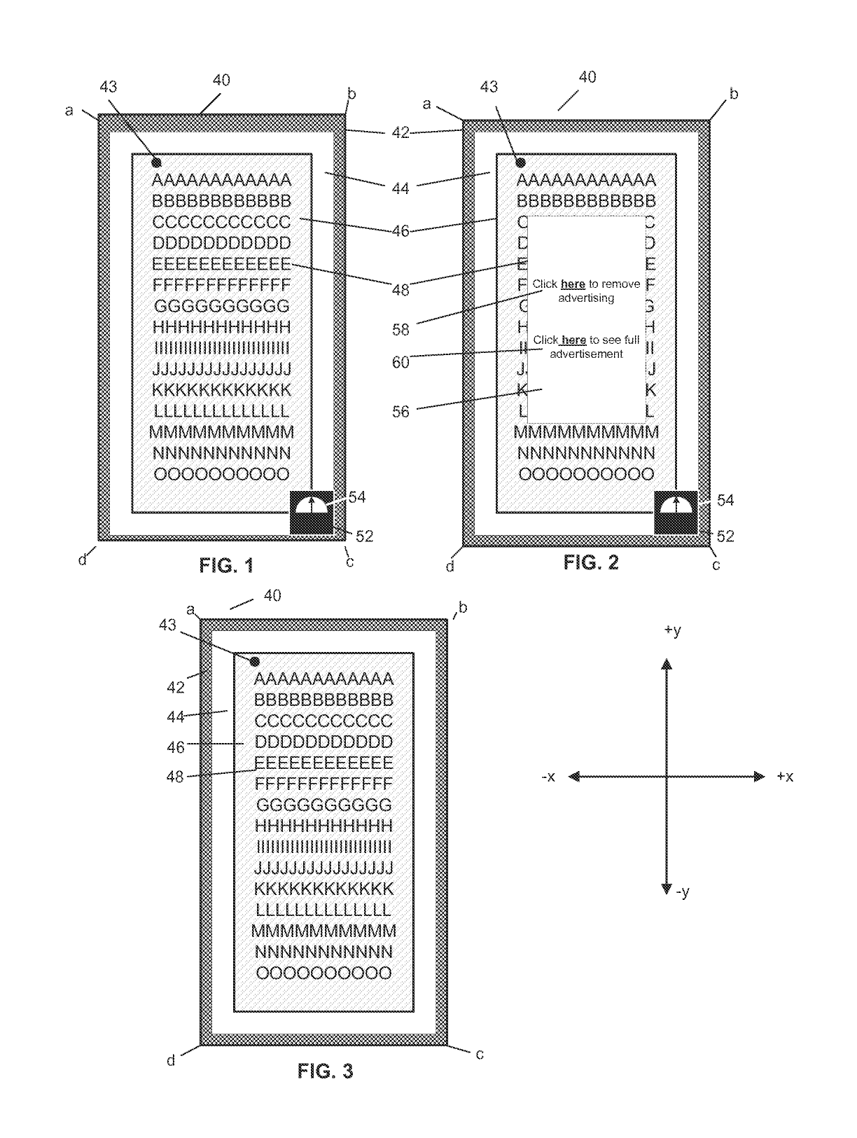

Referring to FIG. 1, a mobile device 40 is depicted in a first (portrait) rotational orientation within a plane perpendicular to the Earth's surface. In the figure, the plane is illustrated as the x-y plane, where the y-axis extends vertically upward from the Earth's surface. Mobile device 40 is preferably a smart device that includes memory, a memory controller, one or more processing units (CPUs), RF circuitry, audio circuitry, a speaker, a microphone, an input output subsystem, and ports for connecting peripheral devices. Mobile device 40 includes a housing 42 and a display 44 that is capable of displaying text, images, movies, videos, icons, animations, and other visual output (collectively, “graphics”) to a user. The memory may include high-speed random access memory and may also include non-volatile memory that acts as a non-transitory computer readable storage medium, such as one or more magnetic disk storage devices, flash memory devices, or other non-volatile solid-state memory devices. Access to the memory by other components of device 40, such as a CPU and/or a peripherals interface may be controlled by a memory controller.

Display 44 is also configured to receive user inputs via selection techniques such as touching, sliding, dragging and dropping, swiping, pressing, and other physical interactions with targeted areas of display 44. Display 44 may use LCD (liquid crystal display) technology, LPD (light emitting polymer display) technology, or LED (light emitting diode) technology, although other display technologies may be used in other embodiments. Display 44 and a display controller (not shown) may detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with display 44. In an exemplary embodiment, projected mutual capacitance sensing technology is used, such as that found in the iPhone® from Apple Inc. of Cupertino, Calif.

Mobile device 40 may also include one or more accelerometers (not shown). In some embodiments, information is displayed on the display 44 in either a portrait view or a landscape view based on an analysis of data received from the one or more accelerometers. Mobile device 40 optionally includes, in addition to accelerometer(s) a magnetometer and a GPS (or GLONASS or other global navigation system) receiver for obtaining information concerning the location and orientation (e.g., portrait or landscape) of mobile device 40.

In some embodiments, the non-volatile memory of mobile device 40 stores one or more of an operating system, a communication module (or set of instructions), a contact/motion module (or set of instructions), a graphics module (or set of instructions), a text input module (or set of instructions), a Global Positioning System (GPS) module (or set of instructions), and applications (or sets of instructions). Suitable exemplary operating systems include the iOS operating system provided by Apple, Inc., the Android operating system provided by Google, Inc. of Mountain View, Calif., the Windows Phone Systems provided by Microsoft Corporation of Redmond, Wash., the WebOS operating system supplied by Hewlett-Packard of Sunnyvale, Calif., Blackberry OS supplied by Blackberry, Ltd. of Waterloo, Canada, and Firefox OS, provided by Mozilla of Mountain View, Calif.

Mobile device 40 may also include a contact/motion module for detecting contact with display 44 (in conjunction with a display controller). The contact/motion module includes various software components for performing various operations related to detection of contact, such as determining if contact has occurred (e.g., detecting a finger-down event), determining if there is movement of the contact and tracking the movement across the display 44 (e.g., detecting one or more finger-dragging events), and determining if the contact has ceased (e.g., detecting a finger-up event or a break in contact). The contact/motion module receives contact data from the display 44. Determining movement of the point of contact, which is represented by a series of contact data, may include determining speed (magnitude), velocity (magnitude and direction), and/or an acceleration (a change in magnitude and/or direction) of the point of contact. These operations may be applied to single contacts (e.g., one finger contacts) or to multiple simultaneous contacts (e.g., “multitouch”/multiple finger contacts).

The contact/motion module may detect a gesture input by a user. Different gestures on display 44 have different contact patterns. Thus, a gesture may be detected by detecting a particular contact pattern. For example, detecting a finger tap gesture includes detecting a finger-down event followed by detecting a finger-up (lift off) event at the same position (or substantially the same position) as the finger-down event (e.g., at the position of an icon). As another example, detecting a finger swipe gesture on the display 44 includes detecting a finger-down event followed by detecting one or more finger-dragging events, and subsequently followed by detecting a finger-up (lift off) event.

Mobile device 40 may also include a graphics module that includes various known software components for rendering and displaying graphics on display 44, including components for changing the intensity of graphics that are displayed. As used herein, the term “graphics” includes any object that can be displayed to a user, including without limitation text, web pages, icons (such as user-interface objects including soft keys), digital images, videos, animations, etc. Mobile device 40 may also include a keyboard with “hard keys” used to effect operations on mobile device 40.

The present disclosure is directed to techniques for providing users applications with advertising. The described techniques are not limited to any particular applications. Examples of possible applications may include applications for providing contacts (e.g., in an address book or contacts list), a telephone dialer interface, video conferencing, social media, e-mail, instant messaging, photographs, videos, music, a web browser, weather information, stock information, and maps, to name but a few possibilities. Users perform operations on mobile device 40 by using controls configured within a user interface provided on display 44. The controls comprise areas of the display 44 that are selectable using particular selection techniques (i.e., a finger swipe, a press, a finger pinch, etc.) to effect desired operations. The user interface may also include graphics. For example, a telephone dialer application may be configured so that selected areas of the display 44 include images of numbers which may be selected to dial (or input) the displayed number for use in placing a call. Thus, the user interface provides controls and graphics to the user. Graphics may be associated with controls or may be displayed without any associated control, depending on the nature of the particular application. Controls may also be provided on particular areas of the display 44 without a graphic or with a graphic that fully or partially overlaps the selectable area associated with the control. As used herein, the term “user interface” refers to a unique arrangement of any, some, or all of an advertising control interface area, an application interface area, an advertising interface area or other interface areas that may be displayed on display 44 at a particular point in time. Thus, FIG. 1 depicts a first user interface, FIG. 2 depicts a second user interface, and FIG. 3 depicts a third user interface.

The user interfaces depicted in FIGS. 1-7, and 9-10 are preferably defined by composites of one or more user interface “views” or “layers.” Each view or layer is a configuration of graphics and controls (as well as their layout or spatial arrangement) within display 44. Modern smart device operating systems typically allow for the creation of “view” classes and subclasses that can be instantiated as corresponding view objects and sub-objects. Each user interface view may be configured to define certain graphics and/or controls that occupy distinct portions or all of display 44, as well as the spatial arrangement of the graphics and/or controls on display 44.

Different views and view objects may be related to one another as “parent” and “child.” The term “parent view” is a relative term, as any given view may be the child of one view and the parent of another. However, in general, a child view object is wrapped in (or contained in) a parent view object. For example, the Android operating system provides a class called “View” that is used to create widgets (buttons, text fields, etc.). The View class is a parent to a “ViewGroup” subclass that defines individual layouts using the defined widgets. The ViewGroup acts as an invisible container that holds other views or other ViewGroups and defines their layout properties. This type of architecture allows multiple interface functionalities to be defined in a single view object that can then be referenced by other computer executable instructions. In accordance with certain examples, the advertising control interface area 52 and the application interface area 46 are both defined by respective view objects that are wrapped or contained in a parent view object.

As is known in the art, certain modern smart device operating systems also allow for the creation of several interface views with a layered architecture. Thus, although it is not physically measurable, there is a depth dimension associated with each of the views. Different techniques are used to achieve a layered architecture. One technique uses a “stack” in which views are positioned one on top of the other. Another technique assigns a z-axis position to the various views. Each interface view provides controls and graphics in an x-y plane and may be related to other interface views along the depth dimension. This type of layered architecture allows interface developers to create user interfaces by selectively bringing different interfaces to the foreground relative to one another. Multiple views may also be displayed at a given time such that the interface area(s) generated by one view will occupy a first portion of the display 44 while an interface area generated by another view will occupy a second portion of the display 44. Multiple views may also be generated at a given time in an overlapping relationship where a first view obscures the other view on display 44 because of the relationship of their depth dimensions.

Referring again to FIG. 1, mobile device 40 includes a display 44 displaying a first user interface that comprises an advertising control interface area 52 and an application interface area 46. In the illustrated example, the application interface area 46 does not occupy the entire display 44. However, in certain preferred examples, the application interface area 46 extends along the entire length and width of display 44. The advertising control interface area 52 is a user-selectable area that may be used to trigger one or more pre-defined operations. The advertising control interface area 52 includes a graphic 54 having content. In FIG. 1 the graphic is a needle-gauge that provides an indication of a number of advertisement identifiers in a first advertisement queue. The graphic may also or alternatively include content that relates to a particular advertisement or advertiser. In FIG. 1 the advertising control interface area 52 is provided in a corner of display 44 and may thus be termed an “advertising corner control interface area.” However, in other examples, the advertising control interface area may be configured as a banner along one of the sides of the user display 44 or in other locations.

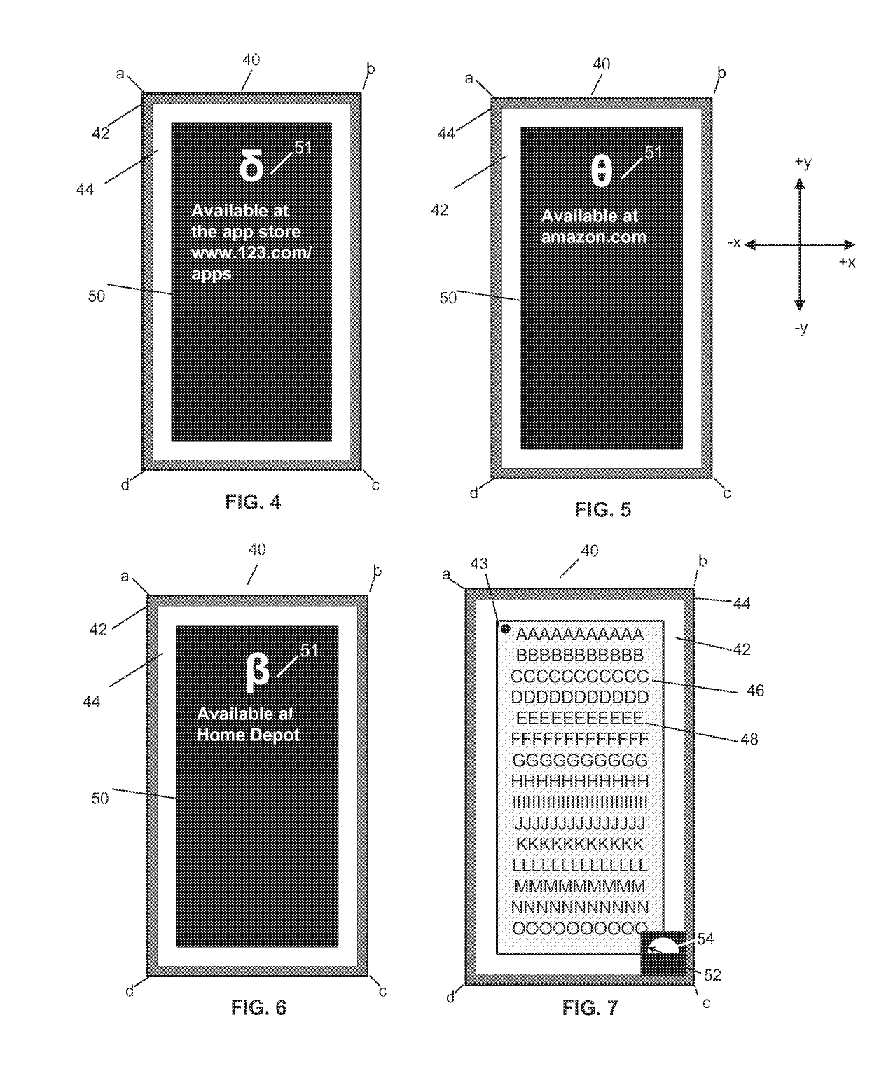

In FIG. 1 the position of the needle in the gauge may be indicative of how many advertisement identifiers remain in the first advertisement queue and/or how many advertisements have been launched by a user of the mobile device from among those advertisements represented by advertisement identifiers in the first advertisement queue. The phrase “advertisement queue” refers to a list or set of advertisement identifiers, each of which uniquely corresponds to a particular advertisement. As explained below, certain applications executed on mobile device 40 may be configured to provide advertising to users. At any particular time on any particular mobile device 40, one or more advertisement queues may be associated with the mobile device 40 and an application executing on the mobile device. In certain cases, the one or more advertisement queues may also be associated with a particular user of the mobile device 40 if a user identifier is associated with the executing application. The advertisement queue may comprise a plurality of files, each of which comprises graphics and computer executable instructions necessary to define a particular advertisement interface area (e.g., FIGS. 4-6). However, in certain preferred examples, the advertisement queue may be resident in the non-volatile or volatile memory of the mobile device 40, in which case it may be preferable to include user-unique advertisement identifiers in the advertisement queue which are transmitted to a remote advertising server to retrieve the necessary graphics for a given advertising interface area at the time it is to be displayed on the display 44. The advertisement identifiers need not take any particular form as long as they uniquely identify the set of files required to display a particular advertising interface area on the mobile device. The user-unique advertisement identifiers may, for example, comprise data strings of letters, numbers, and/or symbols.

In certain examples, the advertising control interface area 52 may include a selectable area that is less than the interface area 52 and/or different from the area of display 44 occupied by graphic 54. However, in the illustrated example of FIG. 1, the graphic 54 covers the entire advertising control interface area 52, and the entire advertising control interface area 52 is selectable by a user to cause the display of a second user interface. One example of such a second user interface is provided in FIG. 4. FIG. 4 depicts a second user interface comprising an advertising interface area 50 on display 44. The advertising interface area 50 includes an advertisement 51 having advertising content that, in certain examples, may be related to the content of a graphic in the advertising control interface area 52 of the first user interface (FIG. 1). As shown in FIG. 4, the advertising interface area 50 does not occupy the entire area of display 44. However, in certain preferred examples it may. A shown in FIGS. 1-3, 7 and 9-10, the application interface area 46 includes application interface content 48, which may comprise controls and/or graphics. In certain examples, the application interface content 48 is scrollable relative to an application interface reference location 43 within application interface area 46.

Referring again to FIG. 4, in preferred examples, the area of display 44 occupied by advertising interface area 50 is greater than the area of display 44 occupied by advertising control interface area 52 and its associated graphic 54. The ratio of the area of display 44 occupied by the advertising interface area 50 to the area of display 44 occupied by advertising control interface area 52 is preferably at least about seven, more preferably at least about ten, and still more preferably at least about twenty. In the same or other examples, the ratio is preferably no more than about 100, more preferably no more than about 65, and still more preferably no more than about 50.

In the example of FIG. 4, the second user interface does not include either the advertising control interface area 52 or the application interface area 46. In certain examples, the advertising interface area 50 may be selectable to take the user to a website where the advertised goods and services can be purchased. In FIG. 4 a link to www.123.com/apps is provided so the user can purchase applications supplied under the δ trademark.

The advertising control interface area 52 provides an indication to the user that the application displayed in application interface area 46 is linked to an advertisement that the user can access by selecting the advertising control interface area 52 (or its graphic 54). In the example of FIG. 4, the second user interface does not include the advertising control interface area 52. However, it may include an alternative control that the user can select to remove or dismiss the advertisement 51 and return to the first user interface of FIG. 1.

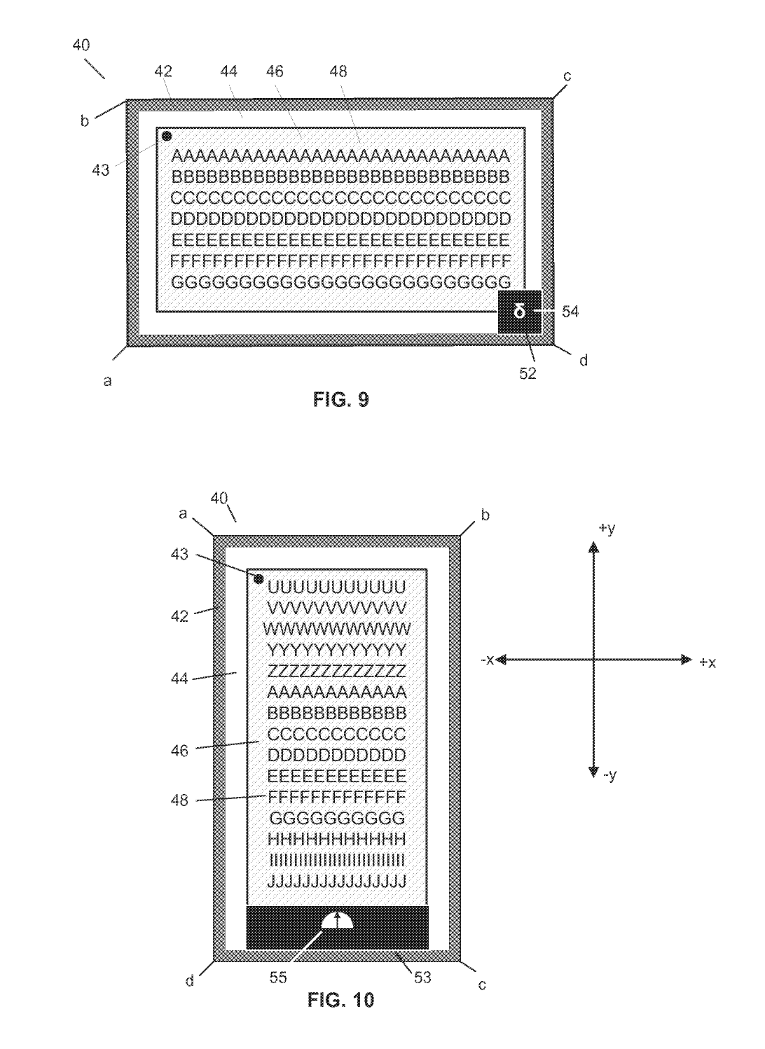

Certain known mobile devices include accelerometers that are used to determine when the mobile device 40 has been rotated by a specified degree of rotation in a plane (e.g., the x-y plane shown FIGS. 1-6) that is perpendicular to the Earth's surface, or put differently, rotated about an axis that is perpendicular to the display 44 and parallel to the Earth's surface. The accelerometer is used to determine the rotational orientation of the mobile device 40 in the plane perpendicular to the Earth's surface and to re-orient the application interface area content 48 so that the upper-left hand corner reference point 43 of the application interface area remains in the upper-left hand corner position when the mobile device 40 is in either the portrait orientation of FIG. 1 or the landscape orientation of FIG. 9 relative to a viewer looking at the display along a viewing direction perpendicular to the x-y plane. Thus, when viewed by a user standing on or seated upright relative to the Earth's surface, application interface area reference point 43 preferably remains in the uppermost and left-most corner relative to the other corners of the display 44 when mobile device 40 is rotated from a portrait to landscape orientation (or vice-versa) in a plane perpendicular to the Earth's surface even if the mobile device 40 is configured to rotate the application interface area 46 and its content 48 relative to a fixed reference point on the mobile device 40 (e.g., one of the corners a-d) in response to the rotation. The term “portrait rotational orientation” refers to an orientation in which the shortest (width) dimension of display 44 is parallel to the Earth's surface, and the term “landscape rotational orientation” refers to an orientation in which the longest (length) dimension of display 44 is parallel to the Earth's surface. In the case of displays that are square, the terms “portrait” and “landscape” simply refer to rotational orientations that are ninety degrees apart from one another and in which a side of the mobile device 40 is parallel to the Earth's surface.

In FIG. 1, mobile device 40 is in a portrait rotational orientation relative to the Earth's surface such that corner a is spaced apart in the positive vertical (y-axis) direction from corner d and corner b is spaced apart from corner c in the positive vertical (y-axis) direction. Corner a is spaced apart from corner b in the negative horizontal (x-axis) direction that is parallel to the Earth's surface, and corner d is spaced apart from corner c in the same direction. Referring to FIG. 9, mobile device 40 is rotated counterclockwise relative to FIG. 1 into a landscape rotational orientation in which corner c is spaced apart from corner d in the positive vertical (y-axis) direction, and corner b is spaced apart from corner a in the same direction. Corner c is spaced apart from corner b in the positive horizontal (x-axis) direction, and corner d is spaced apart from corner a in the same direction. However, in both the first (portrait) rotational orientation of FIG. 1 and the second (landscape) rotational orientation of FIG. 9, the application interface area reference point 43 is spaced apart from the advertising control interface area 52 in the positive vertical (y-axis) direction and the negative horizontal (x-axis) direction. In FIG. 1, the application interface area reference point 43 is spaced apart from the advertising control interface area 52 in the positive vertical (y-axis) direction along the length dimension of the mobile device 40, whereas in FIG. 9 the application interface area reference point 43 is spaced apart from the advertising control interface area 52 in the positive vertical (y-axis) direction along the width dimension of the mobile device 40. This relationship between the application interface area reference point 43 and the advertising control interface area 52 ensures that when the viewer is looking at display 44 while display 44 is in a plane perpendicular to the Earth's surface, the advertising control interface area 52 always appears in the same location on the display relative to the viewer, which in this particular example, is the bottom right hand corner. Thus, in the first (portrait) rotational orientation of FIG. 1, advertising control interface area 52 is proximate corner c, and in the second (landscape) rotational orientation of FIG. 9, advertising control interface area 52 is proximate corner d. If mobile device 40 is rotated another 180 degrees clockwise (from its rotational orientation in FIG. 5), the advertising control interface area 52 will be located in corner b. However, in other examples, the advertising control interface area 52 may appear in other locations of display 44 relative to the application interface area reference point 43.

As mentioned previously, in many known advertising techniques, a user interface is provided which includes a banner ad area and an application interface area. The banner ad is typically rectangular in shape and provided vertically beneath or at the bottom of the application interface area, as illustrated in FIG. 10. In many of these known techniques, the banner ad area is re-sized and rotated when the mobile device is rotated from the first (portrait) rotational orientation of FIG. 1 to the second (landscape) rotational orientation of FIG. 9. However, such techniques are inefficient because in the second (landscape) rotational orientation of FIG. 9, the banner ad often consumes more area on the display 44 than is necessary to allow the user to launch advertising interface area 50 (FIG. 4). Thus, in certain preferred examples herein, the advertising control interface area 52 occupies the same fixed area on display 44 when mobile device 40 is in the first (portrait) rotational orientation of FIG. 1 and the second (landscape) rotational orientation of FIG. 9. The percentage of the total display 44 area occupied by the advertising control interface area 52 is preferably no less than one percent and more preferably no less than two percent. At the same time or in other examples, the percentage of the total display 44 area occupied by the advertising control interface area 52 is preferably no more than about twenty percent and more preferably no more than about fifteen percent. In one example, the advertising control interface area 52 occupies an area of the display 44 that is measured in pixels, and the pixel dimensions of the advertising control interface area 52 remain fixed when the mobile device 40 is rotated from the first (portrait) rotational orientation of FIG. 1 to the second (landscape) rotational orientation of FIG. 9 or vice-versa. In one example, the advertising control interface area is 125×125 pixels. Alternatively, the advertising control interface area may be specified in DPI (dots per inch) or PPI (pixels per inch).

Referring to FIG. 10, advertising control interface area 53 is provided which includes a graphic 55. Advertising control interface area 53 is configured as a banner extending along the width dimension (between corners c and d) of mobile device 40 and spaced apart from the application interface area reference point 43 in the negative y-axis direction. In certain examples, and as illustrated in FIG. 10, the advertising control interface area 53 is preferably provided with “scroll-away” protection. In certain known mobile devices, application content may be scrolled along the length and/or width directions of mobile device 40. In FIG. 1, the application interface area content 48 is shown in a first configuration relative to application interface area reference point 43. After being scrolled along the length direction of mobile device 40, the application interface area content 48 appears in a second configuration relative to application interface area reference point 43, as shown in FIG. 10. The top row of A's in FIG. 1 is scrolled down (in the negative vertical (y) axis direction) and away from application interface area reference point 43 in FIG. 10. In many known advertising solutions, this type of scrolling operation would cause the advertising control interface area 53 to disappear from display 44. However, in preferred examples herein, when a user scrolls application interface area content 48 relative to application interface area reference point 43 (while maintaining mobile device 40 in a fixed rotational orientation within a plane perpendicular to the Earth's surface), the location of advertising control interface area 53 remains fixed relative to the application interface area reference point 43. Such scroll away protection may be provided regardless of whether the advertising control interface area is configured as a corner control as in the case of the advertising control interface area 52 of FIG. 1 or as a banner in the case of advertising control interface area 53 of FIG. 10 or elsewhere in display 44.

Referring now to FIGS. 1, 3, and 4, a method of accessing advertising on mobile device 40 will now be described. In accordance with the method, a user may select advertising control interface area 52 using multiple selection techniques to effect multiple operations, each of which uniquely corresponds to one of the selection techniques. In one example, the user may select advertising control interface area 52 using a first selection technique to display advertising interface area 50 (FIG. 4) and using a second selection technique to dismiss or remove the advertising control interface area 52 from the application interface area 46 (FIG. 3). Thus, this exemplary method allows users to “opt-out” of having advertisements displayed while using selected applications. As discussed further below, in certain examples the advertising control interface area 52 is removable for a selected period of time (the advertising interface control area refresh schedule) which is determined by the operative advertising queue at the time. In one preferred implementation, the selected period of time is determined by the number of advertising identifiers in the queue which correspond to different advertising interface area advertisements 51 (FIGS. 4-6).

Referring again to FIG. 1, in preferred examples, the entire portion of display area 44 occupied by graphic 54 is selectable. In the same or other preferred examples, the same area on display 44 is selectable using both the first and selection techniques to effect the operations to which the techniques respectively correspond. In other examples, the user may use a third selection technique to retain the advertising control interface area 52 but to change the graphic 54 and/or its content as well as the advertisement 51 in advertising interface area 50 to which the graphic content is related. In additional examples, the user may use the particular selection technique to bring up a menu (FIG. 2) with options for displaying the advertising interface area 50 or dismissing the advertising control interface area 52. In further examples, a selection technique may be used (without a menu) that causes the advertising control interface area 52 and/or graphic 54 to temporarily disappear with a new advertising control interface area 52 and/or graphic 54 (or a redisplayed version of the same advertising control interface area 52 and/or graphic 54) subsequently being displayed to the user following a selected period of time dictated by an advertising control interface area display schedule. As indicated previously, the advertising control interface area display schedule may be determined by the number of advertisements that have been displayed or have yet to be displayed from the currently operative advertisement queue.

The first and second selection techniques (or any other selection techniques) preferably comprise unique actions taken with respect to display 44. In one example, briefly contacting (or “clicking”) on advertising control interface area 52 will launch the second user interface of FIG. 4, while longer contact on advertising control interface area 52 will remove (dismiss) the advertising control interface area 52 from display 44 (FIG. 3). In another example, the first selection technique may comprise a single contact with advertising control interface area 52, and the second selection technique may comprise multiple contacts with advertising control interface area 52. In yet another example, the first selection technique may comprise one or more brief contacts with the advertising control interface area 52, and the second selection technique may comprise a brief contact followed by a long contact (i.e., a “tap and hold” technique).

An alternate selection technique is illustrated in FIG. 2. In accordance with this technique, the advertising control interface area 52 is selectable to provide a set of control options, including a menu 56 with a link 60 for generating the second user interface of FIG. 4 and a link 58 for dismissing or removing the advertising control interface area 52 to yield the third user interface of FIG. 3. In certain examples, menu 56 may include a third link for dismissing the particular graphic 54 in advertising control interface area 52 and receiving new content (that is linked to a corresponding advertisement 51 in advertising interface area 50). In certain preferred examples, the entire advertising control interface area 52 is selectable to cause the display of menu 56.

In certain examples, the graphic 54 and/or its content (e.g., the gauge) in the advertising control interface area 52 (FIG. 1) is dynamically updated, as is the advertisement 51 on second user interface of FIG. 4. In one implementation, the content 54 of the advertising control interface area graphic 51 is updated based on a number of advertisements a user has yet to view out of a certain inventory of advertisements, such as by determining the number of advertisement identifiers the user has remaining in an operative advertisement queue. For example, mobile device 40 may be operatively connected to an advertising server over a local area network, wide area network, or the internet, and the particular graphic 54 (or its content) may be retrieved from the server dynamically. In one example, at any given time the mobile device 40 will have an operative advertisement queue associated with the specific application that is executing on device 40, the device 40 itself, and in some cases, the particular user of device 40. Graphics corresponding to the advertisement identifiers in the operative advertisement queue may be sequentially, non-sequentially, or randomly displayed in the advertising control interface area 52. If the graphic 54 includes an indicator of the number of advertisements yet to be displayed, the graphic may be updated (e.g., by moving the needle position) as the number of advertisement identifiers in the queue changes and/or each time an advertising interface area 50 is displayed in response to carrying out the appropriate operation with advertising control interface area 52.

In certain examples, the user interfaces shown in FIGS. 1-7 and 9-10 are defined by compositing multiple user interface views (layers). Referring to FIG. 1, in one example advertising control interface area 52 is defined by an advertising control interface view, and application interface area 46 is defined by an application interface view on which the advertising control interface view is overlaid. The views may define controls and graphics that extend across the entirety of a parent view to which they belong or a portion thereof. However, in FIG. 1 the advertising control interface view defines an advertising control interface area 52 that does not extend beyond the graphic 54 depicted in the figure. Therefore, the advertising control interface view can be overlaid on the application interface view without obscuring much or any of the application interface area 46 or its application interface area content 48. The two views are displayed simultaneously in an overlapping relationship. However, the advertising corner control interface view does not define controls or graphics outside of the advertising control interface area 52. Thus when the views are displayed simultaneously, most or all of the application interface area 46 is visible.

In certain examples, the second user interface of FIG. 4 is defined by an advertising interface view that defines advertising interface area 50. In some embodiments, the application interface view may initially be overlaid on top of the advertising interface view so that the application interface area 46 obscures the advertising 51. In other embodiments involving operating systems that associate interface layers with z-axis coordinates, the advertising interface view used to generate advertising interface area 50 is generated before it is displayed (i.e., the code used to create the advertising interface view is executed before the advertising interface area 50 is displayed) and assigned a z-axis coordinate that is beneath that of the application interface view and the advertising corner control view when the first user interface of FIG. 1 is displayed. In certain examples, the graphics associated with the next advertisement to be displayed (as dictated by the operative advertisement queue) are provided in the advertising interface area 50 if it is generated before it is displayed.

When the second user interface of FIG. 4 is displayed, the z-axis coordinate of the advertising interface view is altered so that it is displayed and the application interface view and advertising corner control views are obscured. In other embodiments that involve operating systems that provide “stacked” layers, the advertising interface view is generated before it is displayed and pushed to a higher (foreground) stack position when the second user interface of FIG. 4 is displayed, and the application interface view and/or advertising corner control interface view is pushed to a lower (background) position when the second user interface of FIG. 4 is displayed. In other examples, the advertising interface view is not provided in a stacked arrangement. Instead, when a user selects the advertising control interface area 52 with a first selection technique, the advertising interface view is generated at that point in time such that it overlays the application interface view and the advertising control interface view.

User interfaces that include distinct areas such as the advertising control interface area 52 and the application interface area 46 may be defined in and generated by a single interface view object created by the application developer. However, in that case each developer would have to separately provide code to generate the advertising corner control interface view that defines the advertising control interface area 52, as well as the code for generating the advertising interface view that defines the advertising interface area 50. In accordance with one optional example, the advertising control interface view is provided as part of a software development kit. As is known in the art, a software development kit, or SDK, is typically a set of software development tools that allows for the creation of applications for a certain software package, software framework, hardware platform, computer system, video game console, operating system, or similar development platform. In accordance with another aspect of the present disclosure, a software development kit is provided which comprises a computer readable medium having a set of computer executable instructions stored on it. When executed by a computer processor, the instructions generate a first user interface view (e.g., an advertising corner control interface view) that includes advertising control interface area 52, which functions as described previously. In certain examples, advertising control interface area 52 is part of an advertising control interface view that overlays a portion of a second user interface view (e.g., an advertising interface view that includes advertising interface area 50 in FIG. 4). In additional examples, the computer executable instructions in the SDK themselves are used to generate the advertising interface view that defines advertising interface area 50. In other examples, code that is separate from the SDK is used to provide the advertising interface view.

In further examples, the computer executable instructions provided as part of the SDK also retrieve graphic content for advertising control interface area 52 from a remote server. The content may be dynamically identified and transmitted to mobile device 40 based on any number of dynamically varying conditions, including, the subject matter of the application interface content 48, the time of day, day of the week, month or season, user preferences, etc. The computer executable instructions may also retrieve advertisement 51 (FIG. 4) that corresponds to the graphic content in graphic 54 (FIG. 9) from the same or a different server.

As mentioned previously, an SDK of the type described herein allows multiple application developers to easily install a uniform advertising solution that can be used to generate the user interfaces of FIGS. 1-7 and 9-10. In one example, the SDK comprises a parent view object that is wrapped around (or contains) the advertising control interface view object (that defines advertising control interface area 52 in FIG. 1), and in some examples, an advertising interface view object (that defines advertising interface area 50 in FIG. 4). In certain examples, the parent view object may be a view object provided by an operating system (e.g., an instantiation of the ViewGroup class for Android operating systems), and in other examples, the parent view object may be an instantiation of a subclass that is part of a larger operating system class (i.e., a class that is defined by the operating system). Additional details of the use of SDKs to provide advertising control interface areas and advertising interface areas are provided in Applicant's co-pending U.S. patent application Ser. No. 13/836,283, filed Mar. 15, 2013 and Ser. No. 13/886,811, filed May 5, 2013, the entire contents of each of which are hereby incorporated by reference.

In certain examples, a user may view a series of advertisements from the operative advertisement queue by performing a defined user gesture on the advertising interface area 50. In one example, a user may perform a right swipe gesture on the advertising interface area 50 of FIG. 4 to display the advertising interface area 50 of FIG. 5, which has different advertising content 51 than the advertising interface area 50 of FIG. 4. The user may then perform an additional user gesture on the advertising interface area 50 of FIG. 5 to display the advertising interface area 50 of FIG. 6. After displaying any of the advertising interface areas 50 of FIGS. 4-6, the user may use a different user gesture to again display the application interface area 46 with the advertising control interface area 52 displayed thereon (FIGS. 1 and 7).

In one example, the mobile device is executing an application that corresponds to and defines application interface area 46 (FIG. 1). An operative advertisement queue includes 50 percent of the number of advertisement identifiers that were present in the queue when the application was launched. As a result, the needle shown in the graphic 54 is at the half-way mark. After performing an advertising control interface area selection gesture, the advertisement interface area 50 of FIG. 4 is displayed. The user then performs a user selection gesture on the advertisement interface area 50 of FIG. 4 to display the advertisement interface area 50 of FIG. 5 and then performs a user selection gesture on the advertisement interface area 50 of FIG. 5 to display the advertisement interface area 50 of FIG. 6. At this point, the user performs a different user selection gesture on the advertisement interface area 50 of FIG. 6 to display the application interface area 46 and advertising control interface area 52 of FIG. 7. Because the user has viewed additional advertisements, the total number of advertisement identifiers in the operative advertisement queue has decreased, and the needle in graphic 54 of FIG. 7 has moved counterclockwise relative to the needle in graphic 54 of FIG. 1.

In certain examples, once a user has viewed all of the advertisements in the operative advertisement queue, the advertising control interface area 52 (FIGS. 1 and 7) will be removed from the application interface area 46 for a selected period of time. This removal constitutes an incentive for the user to view the full advertisements 51 (FIGS. 4-6) associated with the operative queue because it provides a period of time Tᵣ wherein the application interface area 46 can be viewed and used without the advertising control interface area 52 (or preferably any other advertising-related graphics or controls) being displayed on display 44 of mobile device 40.

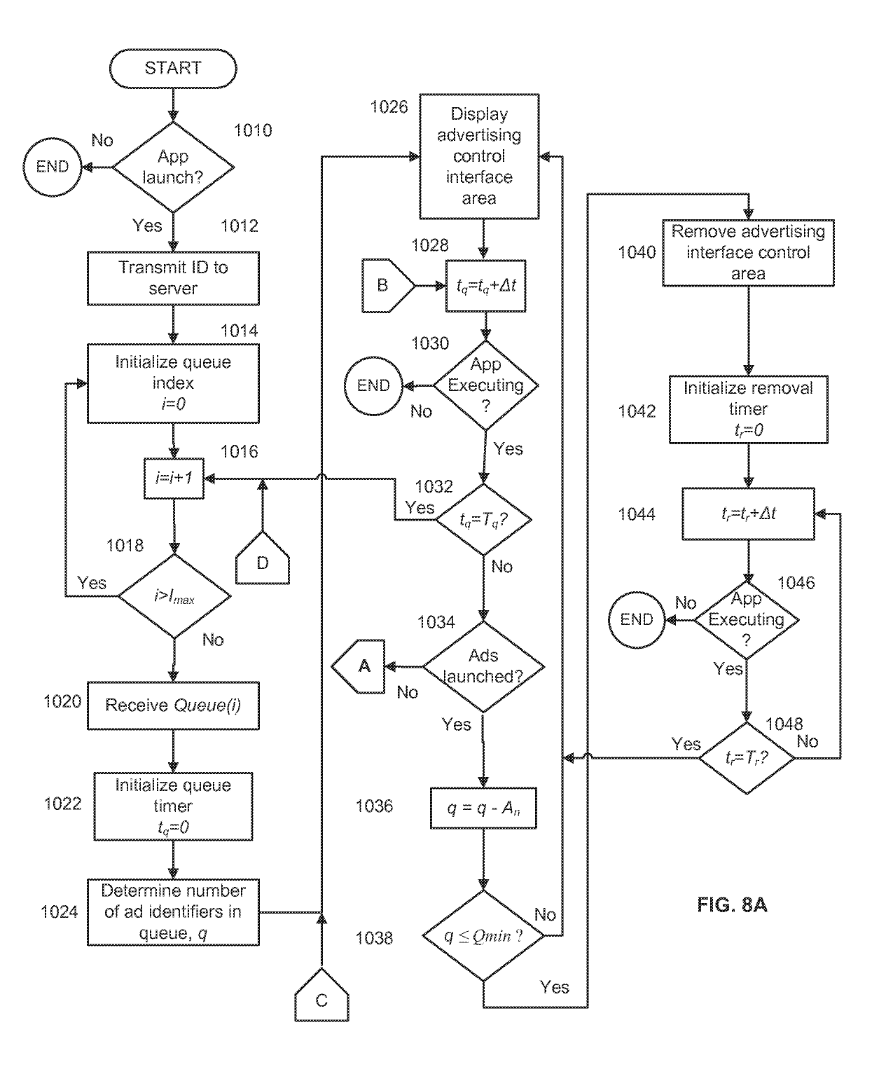

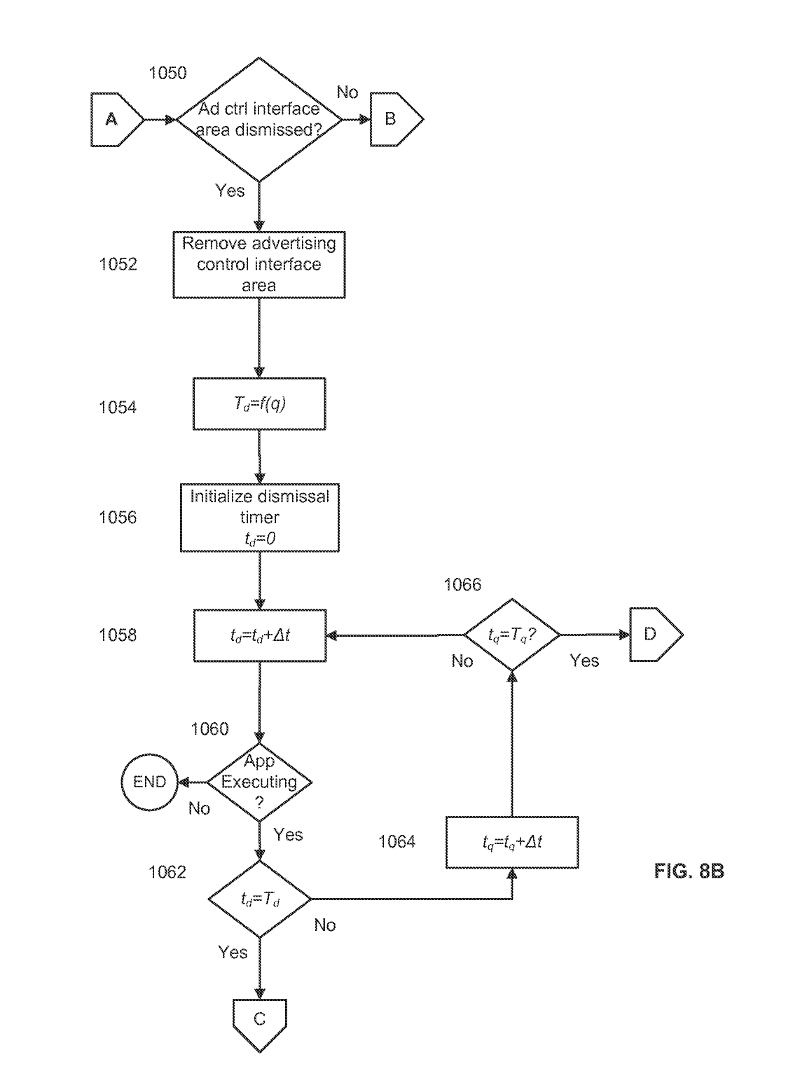

Referring to FIGS. 8A and 8B, a method of providing advertising to a mobile device user is described. In certain examples, the steps of the method are implemented as a set of computer executable process steps stored on a non-volatile memory device in mobile device 40 and executed by a processor on mobile device 40. In certain preferred implementations, the method of FIGS. 8A and 8B is used to deliver advertisements that are selected for delivery based on a bidding process wherein advertisers commit to paying a certain amount of money each time an advertisement is displayed to a user. The advertisers may also specify parameters to target their advertisements to particular users. Such parameters may include any or all of: a day of the week, a month, a season, a holiday, a time of day, a user location, and others. The selection of advertisements based on the bidding process may be carried out by computer executable instructions stored on a non-transitory computer readable medium that is operatively connected to a remote advertising server. Based on the bidding process, at any one time there will be several advertisements that are available for display to a user. The group of several selected advertisements may be referred to as an “advertising campaign.” The advertising campaigns are user and/or user device specific and, in certain examples, will vary throughout a given day. Thus, both the specific advertisements and the number of specific advertisements that constitute a user's operative advertising campaign may fluctuate.

In step 1010 the method determines if an application configured for advertising has been launched (initially executed). If not, the method ends. If the application has been launched, the method proceeds to step 1012 and a mobile device identifier is transmitted to a remote advertising server. The mobile device identifier may be a data string of letters, numbers or symbols (e.g., &, %, *, @, !, etc.) which uniquely identifies mobile device 40. In some instances, multiple users of an application may be able to use the application on the same mobile device. If user identity information is obtained when the application is launched (e.g., by requiring a sign in to identify the particular user), a user identifier may also be transmitted the remote advertising server in step 1012 or as a separate step. The user identifier may also comprise data string of letters, numbers or symbols (e.g., &, %, *, @, !, etc.) which uniquely identifies the user. In certain examples, the remote advertising server uses the mobile device identifier and user identifier (if provided) to select advertisements used to populate the advertisement queues that are provided to mobile device 40. The selection of the advertisements may also be based on the time of day, the identity of the executing application, location of the phone (if configured for geolocation), and personal data stored about the user. As mentioned previously, the selected advertisements may comprise user-specific advertisement campaigns that change throughout the day.

In the method of FIGS. 8A and 8B, advertisements are provided by transmitting a series of “advertisement queues” from the remote advertisement server to the mobile device 40. As described previously, the advertisement queues may comprise a plurality of advertisement identifiers, each of which corresponds to a set of graphics that comprise and render an advertisement. The remote advertisement server may store the graphics in association with the advertisement identifiers comprising the advertising queues. This allows the mobile device 40 to transmit the advertisement identifier for an advertisement that is next to be displayed on mobile device 40 to the server so that the remote server can identify and transmit the correct corresponding graphics. Alternatively, the graphics corresponding to the advertisement identifiers may be stored on the mobile device 40 along with the advertisement identifiers. However, graphics files can be memory intensive and may consume more non-volatile memory on mobile device 40 than is desired.

In step 1013 a current value of a queue refresh period T_{q} is received by the user device. The queue refresh period T_{q} is an interval at which the device user's advertising queue is updated or modified by the remote advertising server. The queue refresh period T_{q} may change throughout a given day based on the nature of the operative advertising campaigns that apply to a given user and based on the advertisements within those campaigns which the user has already viewed. In certain examples, it is preferred not to expose a user to the same advertisement more than a selected number of times per day (or some other time interval). In general, shorter queue refresh periods are used when the number of advertisements which a user has not viewed in the currently operative advertising campaign is larger, and longer queue refresh periods are used when the number of advertisements which a user has not viewed in the currently operative advertising queue is smaller.

In step 1014 an advertisement queue index i is initialized, such as to a value of zero. The advertisement queue index is a number that identifies the particular queue that is being transmitted from among a total number of queues Iₘₐₓ which are available from the remote server for a given mobile device 40 and/or user and based on whatever selection criteria are used to select advertisements to provide to a given mobile device 40 and/or a particular user of the device 40. As discussed below, during the execution of an application, advertisement queues will be refreshed at periodic intervals (the advertisement queue refresh period T_{q}) such as by changing the queue or transmitting a new queue from the remote server. In the particular example of FIGS. 8A and 8B, advertising queues are refreshed by providing a new advertisement queue and incrementing the advertisement queue index i.

In step 1016 the advertisement queue index i is incremented by a selected amount, which is one (1) in FIG. 8A. In step 1018 the method determines if the advertisement queue index i has exceeded the maximum index value Iₘₐₓ. This indicates that all of the available queues have been used during the execution of the application. If the advertisement queue index i has exceeded the maximum index value Iₘₐₓ, control transfers to step 1014 so the index can be reinitialized and the set of available queues can again be used. In other examples, advertising may not be displayed to the user until a new advertising campaign is available or until a selected period of time has elapsed, at which time the queue index will be reinitialized. If step 1018 returns a value of NO, control transfers to step 1019a. In step 1019a, the user device determines whether a new queue refresh period T_{q} is available from the remote advertising. If a new refresh period T_{q} is available, it is received in step 1019b. If a new queue refresh period T_{q} is not available in step 1019a, control transfers to step 1020, and the mobile device 40 receives the queue corresponding to the current value of the queue index (Queue(i)) from the remote advertising server. In other examples, the queue is updated without replacing the remaining advertisement identifiers in the queue. The entire series of advertising queues from i=1 to i=Iₘₐₓ could be stored on the mobile device 40 when the application is launched (step 1010). However, retrieving new queues or new additions to an existing queue from a remote server reduces the amount of mobile device memory that is consumed. In preferred examples, the queue that is transmitted to a user is selected from a user-specific advertising campaign that is operative when step 1020 is executed, and the advertisements corresponding to the queue preferably exclude those advertisements in the operative campaign which have been viewed by the user more than a selected number of times (e.g., 0, 1, 2, 3, 4 or 5 times) during a given time period (e.g., 4 hours, 8 hours, 12 hours, 24 hours, 48 hours, or 72 hours). In such examples, when a user views a specific advertisement, data is transmitted to the remote advertisement server indicating that the advertisement has been viewed by the user so that the number of times a given user has viewed a given advertisement during a given period can be tracked and used in determining the advertisements that will comprise the user's advertisement queues.

As mentioned previously, at periodic intervals (the advertisement queue refresh period T_{q}, the operative advertisement queue stored on mobile device 40 will be replaced with a new queue or otherwise updated. The new queue could include advertisement identifiers from the currently operative queue which correspond to advertisements that have not yet been displayed on mobile device display 44 in addition to new advertisement identifiers. Alternatively, the new queue could include all new advertisement identifiers. A timer is used to determine when the advertisement queue refresh period expires. In step 1022 the queue timer is initialized by setting the timer value t_{q} to an initial value, such as zero.

In step 1024 the number of advertisement identifiers q in the advertisement queue received in step 1020 is determined. Each identifier corresponds to an advertisement 51 provided in an advertisement interface area 50 (FIGS. 4-6) and is used by the remote advertising server to retrieve and transmit the graphics used to generate the advertisement to the mobile device 40. The advertising control interface area 52 is displayed in step 1026 on the application interface area 46 for the executing application launched in step 1010. If the application has just been launched and the first advertisement queue has just been received, in those examples wherein the graphic 54 in the advertising control interface area 52 is a gauge with a needle, the needle will appear fully tilted to the right or left to indicate that the queue is full and that no advertisements have yet been viewed by the user since the application was launched. In other examples, a different type of graphic indicating the number of advertisement identifiers that remain or which have been viewed may be used as graphic 54. Other types of graphics may be used as well, including those with content that relates to the first advertisement identifier in the queue for the first advertisement to be displayed (FIGS. 4-6) once the user executes the appropriate advertising control interface area selection gesture.

In step 1028 the advertisement queue timer value t_{q} is incremented by a timer increment value Δt. A check is made in step 1030 to determine if the application found to be executing in step 1010 is still executing. If not, the method ends. Otherwise, control transfers to step 1032. In step 1032 the method determines whether the queue timer value t_{q} has reached the current advertisement queue refresh period value T_{q}. If it has, control transfers to step 1016, so that the advertisement queue index value i can be incremented and another queue received. The advertising control interface area 52, 53 may be removed until a new queue is received in step 1020. If step 1032 returns a value of NO, control transfers to step 1034, in which the method determines whether any full advertisements have been launched (e.g., FIGS. 4-6) in the manner described previously. When an advertisement is viewed, in certain examples, the advertisement identifier from the queue which corresponds to the advertisement is transmitted to a remote advertising server which sends the graphics necessary to render the advertisement to the mobile device 40 in response to receiving the advertisement identifier. In addition, the advertisement identifier is removed from the queue. Thus, in step 1036 the value of the total number of remaining advertisement identifiers in the currently operative advertisement queue is reduced by the number of consecutive advertisements Aₙ the user has launched and viewed prior to dismissing the advertising interface area 50 (FIGS. 4-6). Thus, if the user is starting from an interface such as the one shown in FIG. 1 and then views the advertisements 51 of FIGS. 4-6, the total number of advertisement identifiers in the operative advertisement queue will be reduced by three (3).

In step 1038 the method determines whether the remaining number of advertisement identifiers q in the advertisement queue is less than or equal to a minimum value Qₘᵢₙ. In preferred examples, the value of Qₘᵢₙ is zero, in which case step 1038 determines if the queue has been depleted. If step 1038 returns a value of No, the advertising control interface area 52 is again displayed (or remains displayed) on the application interface area 46 (step 1026). If the graphic 54 is indicative of the number of advertisement identifiers q remaining in the queue, it may be adjusted to indicate a reduction in the value of q as determined in step 1036. For example, in FIG. 7 the graphic 54 shows the needle farther to the left, indicating that fewer advertisement identifiers remain in the advertisement queue.

If step 1038 returns a value of Yes, then the advertising control interface area 52 is removed from the application interface area 46 (FIG. 3) in step 1040 for a selected removal period Tᵣ. The removal period Tᵣ is received from the remote advertising server in step 1039. In certain examples, the removal period Tᵣ is dynamic and is adjusted based on one or more of the number of advertisements in the currently operative queue, the number of those advertisements in the operative advertising campaign which the user has not yet viewed during a selected period of time, and the advertisements in the currently operative advertising campaign which the user has seen more than a selected number of times during a selected period of time. Thus, the removal period effectively defines a dynamic schedule for re-displaying the advertising control interface area whenever the current advertisement queue is exhausted.

In step 1042 an advertising control interface area removal timer value tᵣ is initialized, such as to a value of zero. In step 1044 the timer value tᵣ is incremented by a timer cycle increment value Δt. In step 1046 the method determines whether the application whose launch was detected in step 1010 is still executing. If not, the method ends. Otherwise, control transfers to step 1048, and the method determines whether the advertising control interface removal timer value tᵣ has reached the selected removal period Tᵣ. If the selected removal period Tᵣ has not been reached, control transfers to step 1044 and the advertising control interface area removal timer value is incremented by the timer cycle increment value Δt. Otherwise, control transfers to step 1016, and the queue index is incremented.

In step 1034 if no advertisements have been launched (i.e., because the user has not performed an advertising control interface area selection gesture on advertising control interface area 52), control transfers to step 1050 on FIG. 8B. In step 1050 the method determines if the user has executed an advertising control interface area dismissal gesture to temporarily remove the advertisement control interface area 52 from the application interface area 46. If not, control transfers to step 1028 and the advertisement queue refresh timer value t_{q} is incremented by the timer cycle increment value. If a Yes value is returned in step 1050, the user has executed an advertising control interface area removal gesture, and in step 1052 the removal is executed. Thus, if a user continues to view advertisements from a given queue, steps 1026-1038 will continue executing until the queue is exhausted or replaced (if the queue refresh period T_{q} expires). In certain examples wherein the advertising control interface area 52, 53 displays a graphic 54, 55 indicative of the number of ads remaining in a queue, the graphic will change to indicate the adjusted number of ads remaining in the queue when step 1026 is re-executed as each advertisement is viewed. In other implementations, the graphic 54, 55 may change without necessarily indicating a number of ads remaining in the queue. For example, the graphic 54, 55 may relate to the graphic 51 in the advertising interface area 50.

If a user uses an application without launching any ads, steps 1026-1034 and 1050 will continue to execute until the queue refresh period T_{q} expires (step 1032). In those examples wherein the advertising control interface area displays a graphic indicative of the number of ads remaining in a queue, the graphic 54, 55 will not change when step 1026 is re-executed as the user continues to use the application without launching any ads. In other implementations, however, graphic 54, 55 may change each time step 1026 is executed without necessarily indicating a number of ads remaining in the queue. For example, the graphic 54, 55 may relate to the graphic 51 in the advertising interface area 50.

As mentioned previously, in certain examples, the period of time during which the advertising control interface area 52 will be removed (FIG. 3) in response to an advertising control interface area dismissal gesture is based on one or more of the number of advertisement identifiers remaining in the advertisement queue, the number of those advertisements in the operative advertising campaign which the user has not yet viewed during a selected period of time, and the advertisements in the currently operative advertising campaign which the user has seen more than a selected number of times during a selected period of time. In certain implementations, the dismissal period T_{d} is increased as the number of advertisement identifiers in the queue decreases to incentivize users to view more full advertisements (e.g., FIGS. 4-6). In preferred examples, the remote advertisement server determines the value of the dismissal period T_{d} based on such considerations. In step 1054 the advertising control interface area dismissal period T_{d} is received from the remote advertisement server. The dismissal period T_{d} defines a schedule for displaying an advertising control interface area which is adjusted in response to one or more of the foregoing factors.

In step 1056 a dismissal timer value t_{d} is initialized such as to zero. In step 1058, the value of the dismissal timer is incremented by the timer cycle increment value Δt. In step 1060 the method determines if the application whose execution was initially detected in step 1010 is still executing. If it is not, the method ends. Otherwise control transfers to step 1062.

In step 1062 the method determines whether the advertising control interface area dismissal timer value t_{d} has reached the value of the dismissal period T_{d}. If it has, control transfers to step 1026 (FIG. 8A), and the advertising control interface area 52 is again displayed on the application interface area 46. Otherwise, in step 1064 the advertisement queue timer value t_{q} is incremented by the timer cycle increment value Δt. In step 1066 the method determines whether the queue timer value t_{q} has reached the advertisement queue refresh period value T_{q}. If it has not, control transfers to step 1058 and the advertising control interface area timer value t_{d} is incremented by the timer cycle increment value Δt. Otherwise, the queue refresh period has expired, and control transfers to step 1016 (FIG. 8A), and the queue index i is incremented. In an alternative implementation, instead of removing advertising for a dismissal period T_{d} in response to a user's dismissal gesture (step 1050), advertising may be removed until the queue refresh period expires as indicated in step 1066.

In certain examples, when each full advertisement 51 is launched, data is transmitted to a remote advertising server and used to determine how often a particular advertisement has been displayed to mobile device users. Each advertisement can be given a unique identifier so that the number of views can be totaled among different mobile devices and different users. Such data allows advertisers to be charged based on the number of times users view their advertisements. Also, in certain examples, steps may be taken to ensure that a user does not receive the same advertisement in one of his or her advertisement queues more than a fixed number of times in a fixed period for a particular application, such as one time in 24 hours. In one implementation, the remote advertising server includes a processor and a non-transitory computer readable medium with computer executable steps stored thereon which select advertisement identifiers to populate the queues for various mobile devices and users, and the computer executable steps may be configured to ensure that no single advertisement identifier is provided to one of the user's queues more than a fixed number of times during a fixed period for a given application.

In certain examples, the same area within advertising control interface area 52 is selectable using different selection techniques to effect different operations, such as dismissing the advertising control interface area 52 or launching a full advertisement (FIGS. 4-6). Without wishing to be bound by any theory, it is believed that the use of such an advertising control interface area 52 is less likely to result in inadvertent or unintentional selection of the advertising control interface area 52 which improves its accuracy as a proxy for user interest in the subject matter of the advertising to which the content in graphic 54 relates. In particular, by providing an advertising control interface area 52 that is selectable using multiple selection techniques, the same overall display area may be selectable for launching the advertising interface area 50 (FIG. 4), dismissing the advertising control interface area 52 (FIG. 3), or changing the content of graphic 54 (and/or the graphic 54 itself) as well as the advertisement 51 linked to it. Thus, in contrast to certain known banner ad techniques, the selectable area for dismissing the advertising control interface area 52 need not be less than the selectable area for launching the advertising interface area 50, which as explained previously, can cause users to mistakenly launch an advertisement instead of dismissing the banner ad.

The method of FIGS. 8A and 8B may also be configured such that if a user has launched a full advertisement (FIGS. 4-6) without taking any further action for a fixed period of time, the advertisement interface area 50 will be removed (dismissed) and control will transfer to step 1026 to re-display the advertising control interface area 52 on the application interface area 46.

In certain examples, advertisers wishing to advertise on applications that use the advertising techniques described herein will undergo a subscription process, preferably with the provider of the above-described software development kit (SDK). The process comprises signing up for an account, providing content for the graphic 54 (e.g., the small letter “delta”, δ, shown in graphic 54) and the advertisement 51 to be shown in the advertising interface area 50. The advertisers may also provide computer executable instructions for generating the advertising interface area 50 and/or an animation used to provide an initial “splash” when users select the advertising control interface area 52. The advertisers would also provide payment information so that they can be charged as users interact with their advertisements in the manner described previously.

In certain examples, advertisers will be provided with a web interface to track their advertising campaigns (such as by tracking how often users select advertising control interface area 52 or advertising interface area 50 with a particular advertiser's advertising and graphic content).

In certain examples, application publishers will also subscribe to receive the above-described SDK. In accordance with such examples, the application publishers will sign up for an account with the SDK provider. The SDK provider will provide a publisher key that uniquely identifies the application publisher. The application publisher will then download the SDK or receive it via a computer readable medium (e.g., a CD or DVD). The publisher will then submit a description of the application to the SDK provider so that the SDK provider can identify suitable advertisers. The SDK provider will then provide the SDK to the application publisher who can then implement the SDK, for example, by creating an application interface view object and wrapping it in the SDK's parent view object, as described previously.

In certain implementations, the advertising control interface area may not be located in a corner of display 44. Referring to FIG. 10, the mobile device 40 of FIG. 1 is depicted in a first portrait orientation in the x-y plane perpendicular to the Earth's surface. However, advertising control interface area 53 is not a generally square region located proximate one of corners a-d. Instead, it occupies an elongated strip extending along the bottom of display 44 and occupying the width of application interface area 46. In certain examples, the advertising control interface area 53 includes a graphic 55 that is of the type known as a “banner ad” in the art. Because the mobile device is in a portrait orientation, the advertising control interface area 53 does not necessarily consume an undesirable amount of area on display 44. However, were it to extend across the entire width (along the x-axis) once the mobile device 40 is rotated to the landscape orientation of FIG. 9, it may consume more area than is desirable. Accordingly, in one implementation, when the mobile device 40 of FIG. 10 is rotated into the landscape orientation, advertising control interface area 53 is re-displayed as advertising control interface area 52 (FIG. 1) which occupies a square region proximate one of the device corners a-d. In certain examples, the amount of display 44 area occupied by advertising control interface area 53 is greater than the area occupied by advertising control interface area 52.

The foregoing descriptions of specific embodiments have been presented for purposes of illustration and description. They are not intended to be exhaustive or to limit the invention to the precise forms disclosed. Many modifications and variations are possible in light of the above teachings, with modifications and variations suited to the particular use contemplated.

What is claimed is:

1. A method of providing advertising on a mobile device having a display, comprising:
receiving a first advertisement queue, the first advertisement queue comprising a first plurality of advertisement identifiers each corresponding to an advertisement in a first plurality of advertisements;
first displaying an advertising control interface area on an application interface area on the mobile device display;
in response to a first user gesture, displaying a first advertisement interface area corresponding to a first advertisement identifier from the first advertising queue;
in response to a second user gesture, displaying a last advertisement interface area corresponding to a last advertisement identifier from the first advertising queue; and
removing the advertising control interface area from the application interface area for a first selected period of time.

2. The method of claim 1, further comprising second displaying an advertising control interface area on the application interface area after the first selected period of time has elapsed.

3. The method of claim 2, wherein the step of removing the advertising control interface area from the application interface area for a first selected period of time comprises first removing the advertising control interface area from the application interface area for the first selected period of time, the method further comprising:
receiving a second advertisement queue following the second user gesture, the second advertisement queue comprising a second plurality of advertisement identifiers each corresponding to an advertisement in a second plurality of advertisements; and
second removing the advertising control interface area after an advertisement queue refresh period has expired following the step of second displaying an advertising control interface area on the application interface area.

4. The method of claim 3, wherein the advertisement queue refresh period is greater than the first selected period of time.

5. The method of claim 2, further comprising:
adding an additional advertisement identifier to the first advertisement queue after an advertisement queue refresh period has elapsed, wherein the step of second displaying an advertising control interface area on the application interface area occurs after the step of adding an additional advertisement identifier to the first advertisement queue.

6. The method of claim 1, wherein the step of first displaying an advertising control interface area comprises displaying a graphic indicative of a total number of advertisement identifiers comprising the first plurality of advertisement identifiers in the first advertisement queue.

7. The method of claim 6, wherein the advertisement identifiers in the first plurality of advertisement identifiers correspond to advertisements that have not yet been displayed on the mobile device display during an advertisement queue refresh period.

8. The method of claim 7, wherein the advertisement queue refresh period is a continuous period during which a selected application is executing on the mobile device.

9. The method of claim 6, wherein the step of first displaying an advertising control interface area on the application interface is carried out before the first user gesture is performed, and the method further comprises displaying a second graphic indicative of a second number of advertisement identifiers comprising a second plurality of advertisement identifiers in a second advertisement queue.

10. The method of claim 6, further comprising:
adding at least one advertisement identifier to the first advertisement queue such that the first advertisement queue comprises a second total number of advertisement identifiers comprising a second plurality of advertisement identifiers, wherein the step of first displaying an advertising control interface area on the application interface area is carried out before the first user gesture is performed and further comprises displaying a second graphic indicative of the second total number of advertisement identifiers in the second advertisement queue.

11. The method of claim 1, wherein the first user gesture comprises an advertising control interface area selection gesture.

12. The method of claim 1, further comprising:
in response to an advertising interface area dismissal gesture, second displaying the advertising control interface area on the application interface area on the mobile device.

13. The method of claim 1, wherein the step of first displaying the advertising control interface area further comprises displaying a sequence of different advertising graphics in the advertising control interface area.

14. The method of claim 1, wherein the step of first displaying the advertising control interface area on the application interface area further comprises displaying the advertising control interface area in a corner of the mobile device display.

15. The method of claim 1, wherein in response to an advertising control interface area dismissal gesture, the method further comprises removing the advertising control interface area from the application interface area for a second selected period of time.

16. The method of claim 15, wherein the second selected period of time is based on the total number of advertisement identifiers in the first advertisement queue.

17. The method of claim 1, further comprising removing a first advertisement identifier corresponding to the first advertisement from the first advertisement queue in response to the first user gesture.

18. The method of claim 17, further comprising removing a last advertisement identifier corresponding to the last advertisement from the last advertisement queue in response to the second user gesture.

19. The method of claim 1, further comprising:
detecting the launching of an application on the mobile device, wherein the launching of the application causes the displaying of the application interface area on the mobile device display; and
transmitting data to an advertising server, wherein the transmitted data indicates the launching of the application on the mobile device.

20. The method of claim 19, wherein the step of receiving the first advertisement queue occurs after the step of detecting the launching of the application on the mobile device.

21. The method of claim 19, wherein the transmitted data further uniquely identifies at least one of the mobile device and a user of the mobile device.

22. The method of claim 21, wherein the first advertisement queue corresponds to the transmitted data that uniquely identifies the mobile device.

23. The method of claim 1, wherein during a second selected period of time, the same advertisement is not displayed on the mobile device more than a selected number of times.

24. The method of claim 23, wherein the second selected period of time is one day.

25. A mobile device, comprising:
a processor;
a non-transitory computer readable storage medium having computer executable instructions stored thereon, wherein when executed by the processor, the computer executable instructions perform the method of claim 1.

26. A method of providing advertising on a mobile device having a display, comprising:
first displaying an advertising control interface area on an application interface area on the mobile device display in accordance with a first advertising control interface area display schedule;
adjusting a value of a first total number of advertisements to be displayed to yield a second total number of advertisements to be displayed, wherein each advertisement in the first total number of advertisements to be displayed corresponds to an advertisement identifier in a first advertisement queue, and the first total number of advertisements to be displayed corresponds to a first total number of advertisement identifiers in the first advertising queue;
modifying the first advertising control interface area display schedule to yield a second advertising control interface area display schedule based on the second total number of advertisements to be displayed; and
second displaying an advertising control interface area on the application interface area in accordance with the second advertising control interface area display schedule.

27. The method of claim 26, wherein the step of first displaying an advertising control interface area on the application interface area comprises displaying a graphic including content indicative of the first total number of advertisements to be displayed.

28. The method of claim 27, wherein the step of second displaying an advertising control interface area on the application interface area comprises displaying a graphic including content indicative of the second total number of advertisements to be displayed,

29. The method of claim 26, further comprising displaying a first advertisement interface area corresponding to a first advertisement identifier from the first advertising queue in response to a first advertising control interface area selection gesture.

30. The method of claim 29, wherein the step of adjusting a value of a first total number of advertisements to be displayed is performed after the first advertising control interface area selection gesture, and the second total number of advertisements to be displayed is less than the first total number of advertisements to be displayed.

31. The method of claim 26, further comprising receiving a second advertisement queue comprising a second total number of advertisement identifiers, wherein each advertisement identifier in the second advertisement queue corresponds to an advertisement to be displayed, and the second total number of advertisement identifiers is the second total number of advertisements to be displayed.

32. The method of claim 31, wherein the step of receiving a second advertisement queue comprising a second total number of advertisement identifiers occurs after an advertisement queue refresh period has elapsed following the step of first displaying an advertising control interface area on the application interface area in accordance with a first advertising control interface area display schedule.

33. The method of claim 26, wherein the step of adjusting a value of a first total number of advertisements to be displayed to yield a second number total number of advertisements to be displayed further comprises adding at least one advertisement identifier to the first advertisement queue.

34. The method of claim 33, wherein the step of adjusting a value of a first total number of advertisements to be displayed to yield a second number total number of advertisements to be displayed occurs after an advertisement queue refresh period has elapsed following the step of first displaying an advertising control interface area on the application interface area in accordance with a first advertising control interface area display schedule.

35. The method of claim 26, wherein the first advertising control interface area display schedule defines a first selected period at which an advertising control interface area is displayed after being dismissed, the second advertising control interface area display schedule defines a second selected period at which an advertising control interface area is displayed after being dismissed, and the first selected period is greater than the second selected period.

36. The method of claim 26, further comprising the steps of:
displaying a first advertising interface area comprising a first advertisement in response to a first advertising control interface area selection gesture, and the step of adjusting a value of a first total number of advertisements to be displayed to yield a second total number of advertisements to be displayed is performed in response to the first advertising control interface area selection gesture.

37. The method of claim 36, further comprising:
in response to a second user gesture, modifying the second advertising control interface area display schedule to yield a third advertising control interface area display schedule; and
third displaying the advertising control interface area on the display in accordance with the third advertising control interface area display schedule.

38. The method of claim 26, wherein during a selected period, the same advertisement is displayed not more than a selected number of times.

39. The method of claim 26, wherein the step of first displaying an advertising control interface area in accordance with a first advertising control interface area display schedule comprises displaying the advertising control interface area in a corner of the mobile device display.

40. The method of claim 26, wherein the step of first displaying an advertising control interface area comprises sequentially displaying a plurality of graphics in the advertising control interface area.

41. The method of claim 26, further comprising:
determining that an application corresponding to the application interface area has been launched;
transmitting data to a server comprising an identifier corresponding to at least one of the mobile device and a user of the mobile device; and
receiving the first advertisement queue following the step of transmitting data to the server.

42. A mobile device, comprising:
a processor;
a non-transitory, computer readable storage medium having computer executable instructions stored thereon, wherein when executed by the processor, the computer executable instructions perform the method of claim 26.

43. A method of providing advertising on a mobile device having a display, comprising:
first displaying an advertising control interface area on an application interface area on the display;
removing the advertising control interface area from the application interface area for a selected period of time when a number of advertisement identifiers in an advertisement queue reaches a selected number.

44. The method of claim 43, wherein the selected number is zero.

45. The method of claim 43, wherein the step of first displaying an advertising control interface area is performed when the number of advertisement identifiers in the advertisement queue is greater than the selected number.

46. The method of claim 43, wherein the step of first displaying an advertising control interface area further comprises displaying a graphic having content indicative of the number of advertisement identifiers in the advertisement queue.

47. The method of claim 43, further comprising second displaying an advertising control interface area on the application interface area after the selected period of time has elapsed.

48. The method of claim 43, further comprising determining that a user has performed an advertising control interface selection gesture and removing an advertisement identifier from the advertisement queue.

49. The method of claim 43, further comprising determining that a user has launched a number of advertisements, wherein each advertisement corresponds to an advertisement identifier in the advertisement queue, and removing the advertisement identifiers from the advertisement queue which correspond to the launched advertisements.

50. The method of claim 43, wherein the advertisement queue is a first advertisement queue, the method further comprises receiving a second advertisement queue having a number of advertisement identifiers, and second removing the advertising control interface area from the application interface area for the selected period time when the number of advertisement identifiers in the second advertisement queue reaches the selected number.

51. A mobile device, comprising:
a processor;
a non-transitory computer readable storage medium having computer executable instructions thereon, wherein when executed by the processor, the computer executable instructions perform the method of claim 43.

52. The mobile device of claim 51, wherein the selected number is zero.

53. The mobile device of claim 51, wherein the step of first displaying an advertising control interface area is performed when the number of advertisement identifiers in the advertisement queue is greater than the selected number.

54. The mobile device of claim 51, wherein the step of first displaying an advertising control interface area further comprises displaying a graphic having content indicative of the number of advertisement identifiers in the advertisement queue.

55. The mobile device of claim 51, wherein when executed by the processor, the computer executable instructions perform the further step of second displaying an advertising control interface area on the application interface area after the selected period of time has elapsed.

56. The mobile device of claim 51, wherein when executed by the processor, the computer executable instructions perform the further step of determining that a user has performed an advertising control interface selection gesture and removing an advertisement identifier from the advertisement queue.

57. The mobile device of claim 51, wherein when executed by the processor, the computer executable instructions perform the further steps of determining that a user has launched a number of advertisements, wherein each advertisement corresponds to an advertisement identifier in the advertisement queue, and removing the advertisement identifiers from the advertisement queue which correspond to the launched advertisements.

58. The mobile device of claim 51, wherein the advertisement queue is a first advertisement queue, and when executed by the processor, the computer executable instructions perform the further steps of receiving a second advertisement queue having a number of advertisement identifiers, and second removing advertising control interface area from the application interface area for the selected period of time when the number of advertisement identifiers in the second advertisement queue reaches the selected number.
